(19) United States
(12) Patent Application Publication
(10) Pub. No.: US 2025/0187033 A1
(43) Pub. Date: Jun. 12, 2025

(54) Garden Hose Nozzle

(71) Applicant: SHIN TAI SPURT WATER OF THE GARDEN TOOLS CO., LTD., Changhua County (TW)

(72) Inventor: Chin-Yuan Chen, Changhua County (TW)

(73) Assignee: SHIN TAI SPURT WATER OF THE GARDEN TOOLS CO., LTD., Changhua County (TW)

(21) Appl. No.: 18/532,208

(22) Filed: Dec. 7, 2023

(51) Int. Cl. B05B 15/65

(52) U.S. Cl. CPC B05B 15/65

(57) ABSTRACT

A garden hose nozzle includes a hose nozzle body, at least one sprinkler head, and a water stop ring. The hose nozzle body includes a barrel part, one end of the barrel part is formed with a port, an inner wall of the barrel part is provided with two stoppers, two entrance channels, and two swivel slots. The stopper is formed a limiting block protruding from an inner end close to one side of the entrance channel, and the limiting block is provided a first inclined guide surface. A sleeve pipe extends from one end of the sprinkler head, an outer wall of the sleeve pipe is provided with two projecting ribs, and the projecting rib is formed a second inclined guide surface.

### BACKGROUND OF THE INVENTION

### Field of the Invention

This invention relates to a gardening hose nozzle structure that can be used to disassemble and assemble the sprinkler head with bare hands.

### Description of the Related Art

In gardening work, flowers, plants and trees must be watered regularly to prevent the plants from drying due to lack of water. When plants are planted in a wide range or far away from water sources, the water hose is used to pour. However, the water flowing directly from the water hose cannot be watered over a large area, the watering process is slow, and it is easy to damage the plants. Therefore, a sprinkler or a nozzle is installed at the end of the water hose. In order to utilize the characteristics of the water spray nozzle that can spray water over a large area to achieve more efficient irrigation, the conventional water spray nozzle is equipped with a water spray head, and the front end surface of the water spray head is equipped with several water outlets with different water splash shapes. By holding and rotating the water spray head, the effect of spraying water with different water splashes can be achieved.

However, the conventional structure as mentioned above has the following problems in practical application. (1) The water spray head is fixed on the water spray nozzle through screw locking or high-frequency welding. It is difficult or impossible to remove it with bare hands. Therefore, it is difficult for the water spray nozzle to have different spray shapes. (2) Since the sprinkler head is difficult or impossible to remove when the sprinkler head is damaged or malfunctions, the user may directly abandon the whole water spray nozzle, and it is not environmentally friendly.

### SUMMARY OF THE INVENTION

It is known that the water spray head of the conventional water spray nozzle is difficult to remove with bare hands, and this is the technical problem to be solved by this application.

This invention provides a garden hose nozzle including a hose nozzle body, at least one sprinkler head, and a water stop ring. The hose nozzle body includes a barrel part, one end of the barrel part is formed with a port, the inner wall of the barrel part is provided with a stopping part protruding inward, the stopping part has a first stopping surface close to the port, and two stoppers are protruding from the inside of the stopping part and are spaced apart from each other. An entrance channel is formed between both sides of the two stoppers, and the two stoppers each form a swivel slot in the direction away from the port, the swivel slot has a closed bottom, and the opening of the swivel slot is connected to the entrance channel. The stopper is formed a limiting block protruding from the inner end close to one side of the entrance channel, and the limiting block is provided a first inclined guide surface. A sleeve pipe extends from one end of the sprinkler head, the outer wall of the sleeve pipe is provided with two projecting ribs that are spaced apart from each other, the projecting rib is formed a second inclined guide surface, and the sleeve pipe is provided with a second stopping surface for the water stop ring to abut and limit the axial direction movement of the water stop ring. When the water stop ring is sleeved on the sleeve pipe, the sleeve pipe can be inserted into the barrel part of the hose nozzle body from the port by aligning the projecting rib and the entrance channel. The water stop ring is axially pushed and squeezed by the first stopping surface and the second stopping surface at the same time, and the water stop ring is also radially pressed by the inner side of the stopping part and the outer side of the sleeve pipe. Cooperating with the elasticity of the water stop ring, the sprinkler head will not easily move relative to the hose nozzle body. Then, the sprinkler head is rotated in one direction after insertion, so that the projecting rib can use the mutual guidance of the second inclined guide surface and the first inclined guide surface to smoothly cross the limiting block and then turn into the swivel slot. The water stop ring is supported between the hose nozzle body and the sprinkler head, and the elasticity of the water stop ring can also be used to actively push the sprinkler head to drive the projecting rib outward to snap into the swivel slot. The sprinkler head can pass through the limitation of the projecting rib caused by the stopper and the limiting block, so that it can no longer be arbitrarily separated from the hose nozzle body, thereby eliminating the need for additional tools. The advantage of disassembly and assembly of the sprinkler head on the hose nozzle body can be completed.

With the structure of this application, the following benefits can be obtained. (1) The sprinkler head can be disassembled and assembled with bare hands, so it can be replaced with different water sprays according to actual use needs. The sprinkler head of different shapes or models will be more flexible in use, and there is no need to prepare multiple water spray guns at the same time for a variety of different water spray needs. (2) The sprinkler head can be disassembled and assembled with bare hands, so when the sprinkler head fails or is damaged, it can be easily replaced, which is relatively energy-saving, avoids waste, and is more environmentally friendly.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional combination diagram of this application.

FIG. 2 is a three-dimensional exploded diagram of this application.

FIG. 3 is an exploded cross-sectional view of this application.

FIG. 4 is a diagram showing the insertion state of this application during assembly.

FIG. 5 is a diagram showing the rotation state of this application during assembly.

FIG. 6 is a diagram showing the stuck state of this application during assembly.

FIG. 7 is a three-dimensional view of this application after the replacement of another sprinkler head.

FIG. 8 is a diagram showing the pressed state of another sprinkler head of this application when it is disassembled.

FIG. 9 is a diagram showing the rotation state of another sprinkler head of this application when it is disassembled.

FIG. 10 is a diagram showing the detached state of another sprinkler head of this application when it is disassembled.

FIG. 11 is a diagram showing the separation state of another sprinkler head of this application when it is disassembled.

### DETAILED DESCRIPTION OF THE INVENTION

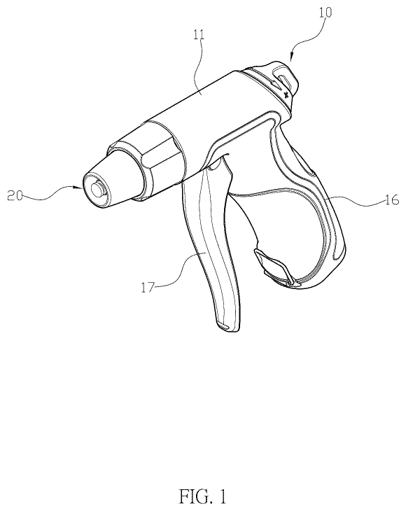

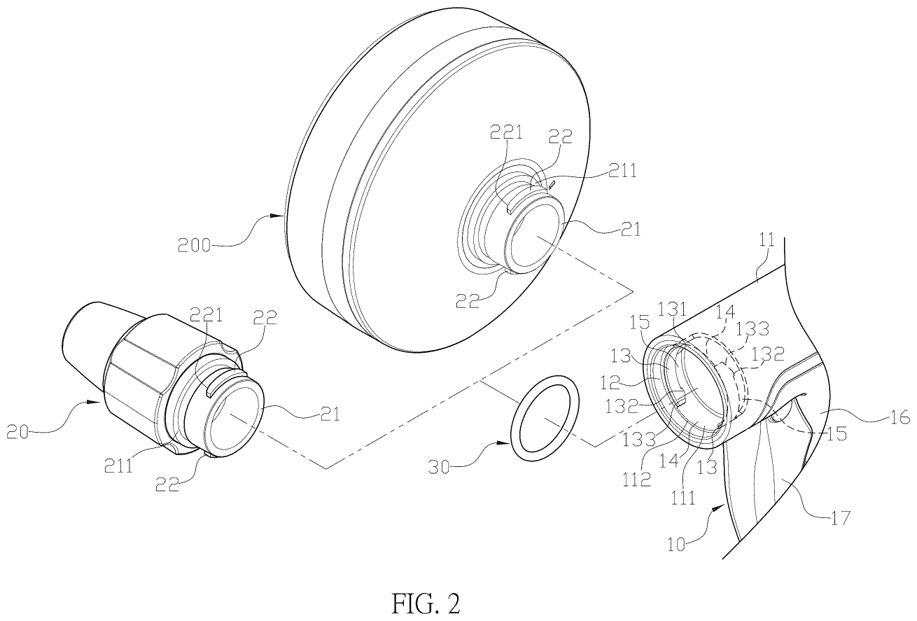

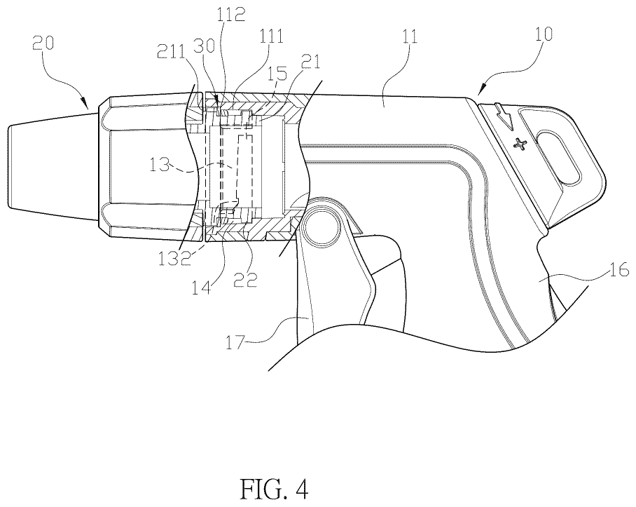

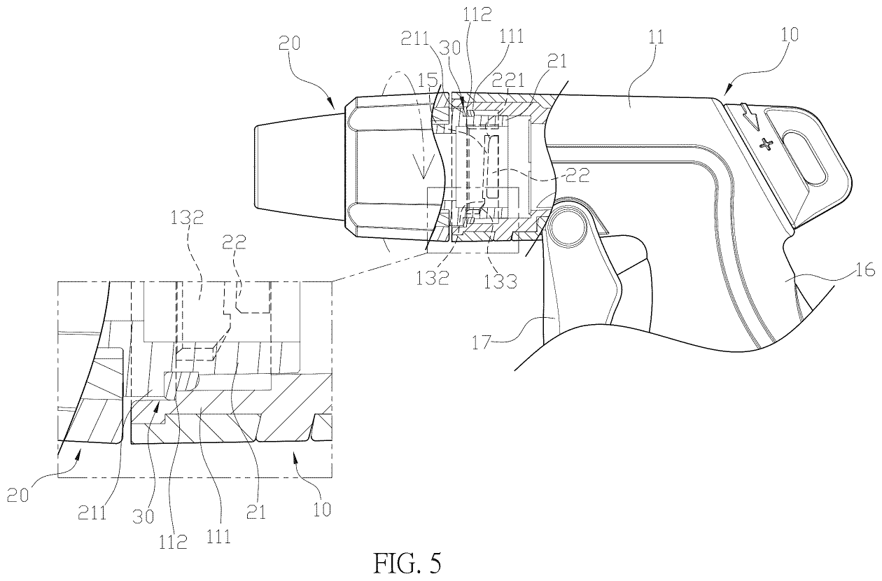

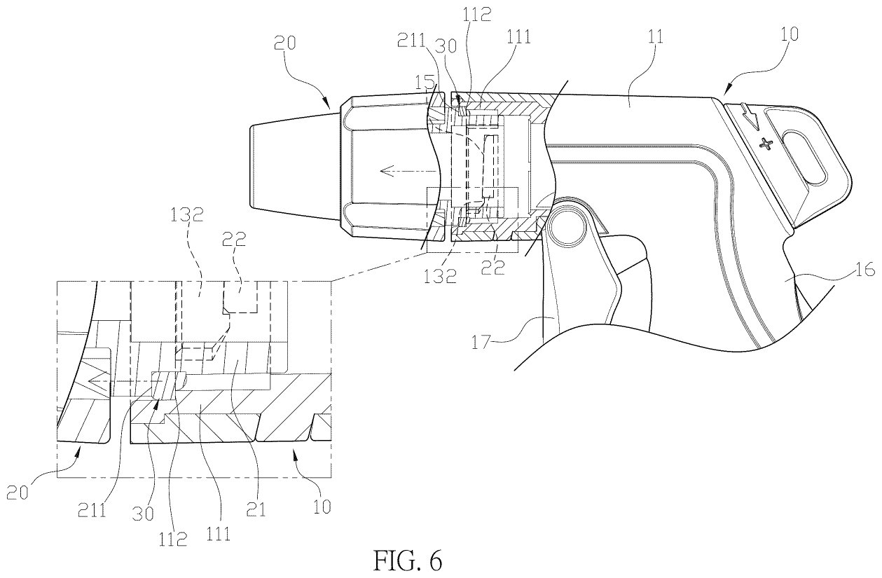

First, as shown in FIGS. 1-3, a garden hose nozzle includes a hose nozzle body 10, at least one sprinkler head 20, and a water stop ring 30. The hose nozzle body 10 includes a barrel part 11, one end of the barrel part 11 is formed with a port 12, the inner wall of the barrel part 11 is provided with a stopping part 111 protruding inward, the stopping part 111 has a first stopping surface 112 close to the port 12, and two stoppers 13 are protruding from the inside of the stopping part 111 and are spaced apart from each other. An entrance channel 14 is formed between both sides of the two stoppers 13, and the two stoppers 13 each form a swivel slot 15 in the direction away from the port 12, the swivel slot 15 has a closed bottom, and the opening of the swivel slot 15 is connected to the entrance channel 14. The stopper 13 is formed a limiting block 132 protruding from the inner end 131 close to one side of the entrance channel 14, and the limiting block 132 is provided a first inclined guide surface 133. A sleeve pipe 21 extends from one end of the sprinkler head 20, the outer wall of the sleeve pipe 21 is provided with two projecting ribs 22 that are spaced apart from each other, the projecting rib 22 is formed a second inclined guide surface 221, and the sleeve pipe 21 is provided with a second stopping surface 211 for the water stop ring 30 to abut and limit the axial direction movement of the water stop ring 30. When the water stop ring 30 is sleeved on the sleeve pipe 21, the sleeve pipe 21 can be inserted into the barrel part 11 of the hose nozzle body 10 from the port 12 by aligning the projecting rib 22 and the entrance channel 14, as shown in FIG. 4. The water stop ring 30 is axially pushed and squeezed by the first stopping surface 112 and the second stopping surface 211 at the same time, and the water stop ring 30 is also radially pressed by the inner side of the stopping part 111 and the outer side of the sleeve pipe 21. Cooperating with the elasticity of the water stop ring 30, the sprinkler head 20 will not easily move relative to the hose nozzle body 10. Then, the sprinkler head 20 is rotated in one direction after insertion, so that the projecting rib 22 can use the mutual guidance of the second inclined guide surface 221 and the first inclined guide surface 133 to smoothly cross the limiting block 132 and then turn into the swivel slot 15, as shown in FIG. 5. The water stop ring 30 is supported between the hose nozzle body 10 and the sprinkler head 20, and the elasticity of the water stop ring 30 can also be used to actively push the sprinkler head 20 to drive the projecting rib 22 outward to snap into the swivel slot 15, as shown in FIG. 6. The sprinkler head 20 can pass through the limitation of the projecting rib 22 caused by the stopper 13 and the limiting block 132, so that it can no longer be arbitrarily separated from the hose nozzle body 10, thereby eliminating the need for additional tools. The advantage of disassembly and assembly of the sprinkler head 20 on the hose nozzle body 10 can be completed.

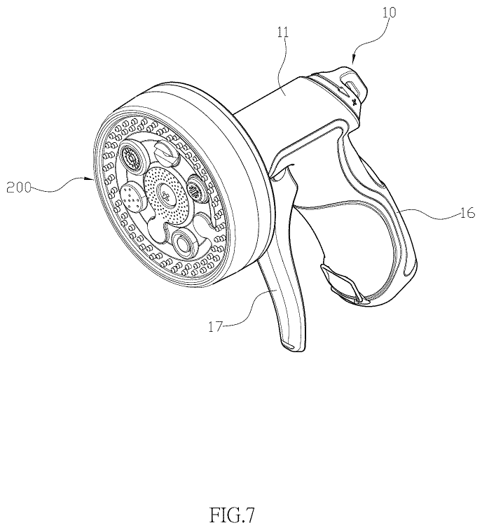

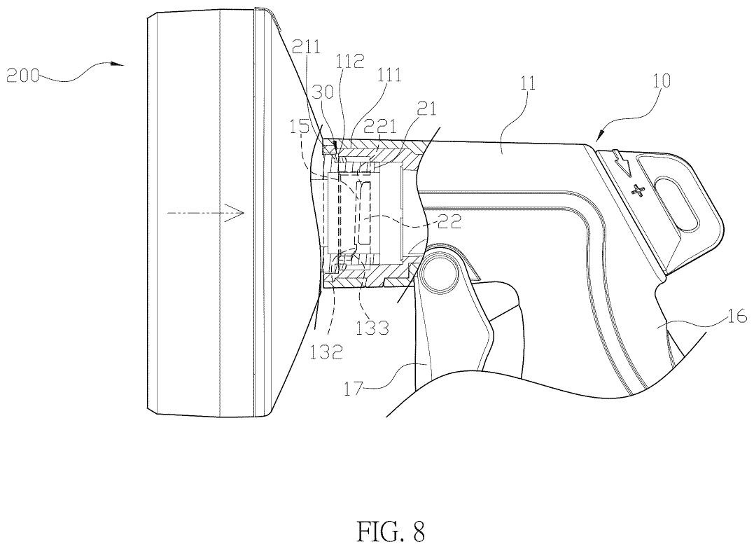

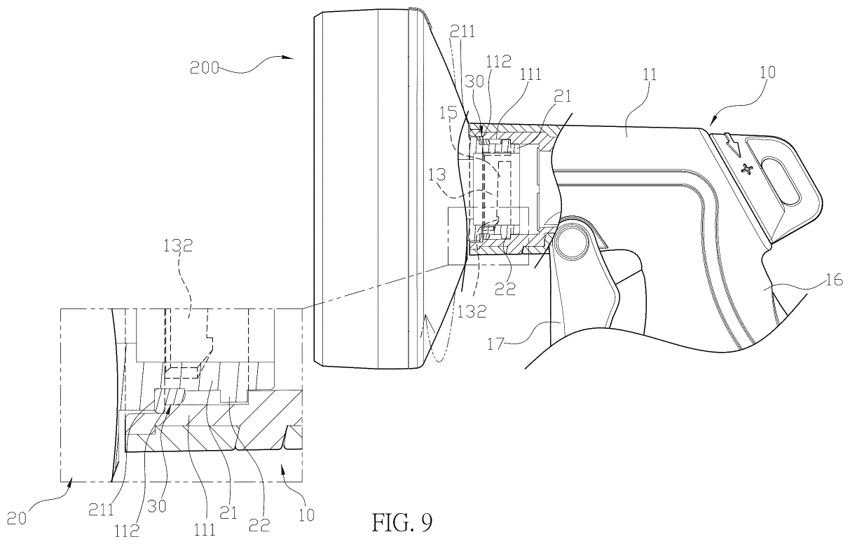

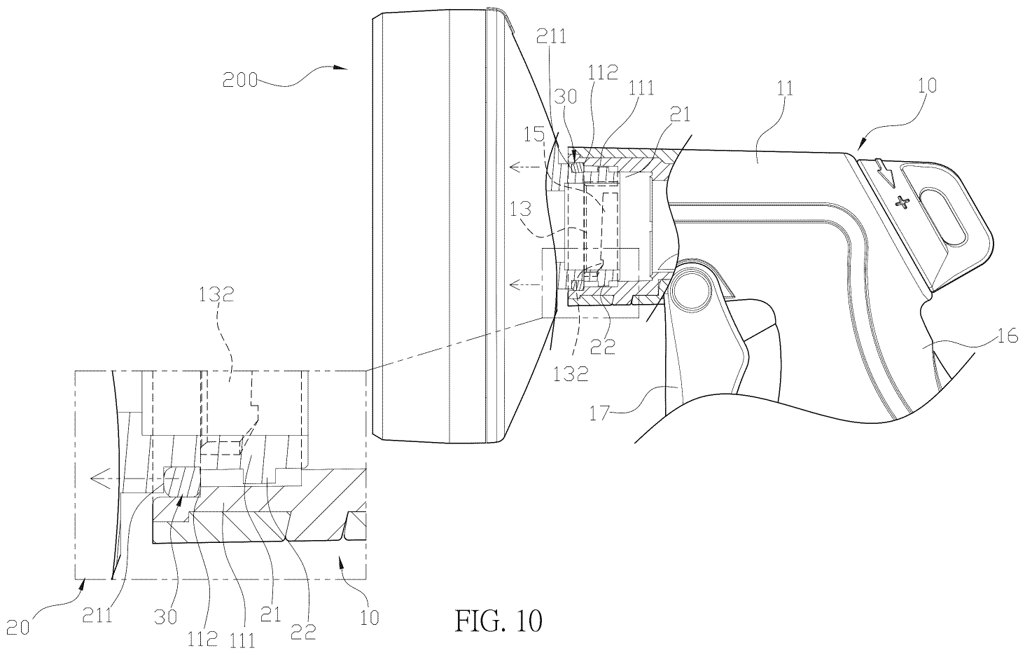

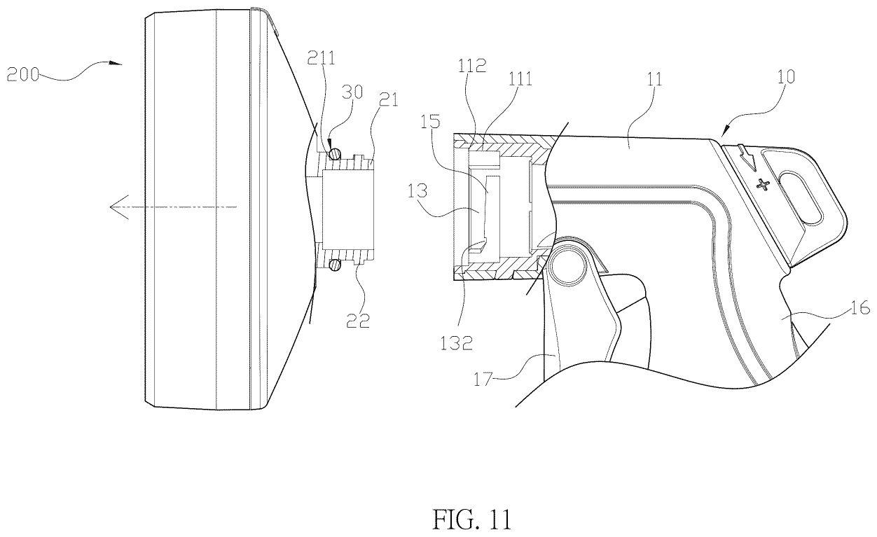

If the user wants to replace another water spray head 200 during use, the user can press the sprinkler head 20 originally installed on the hose nozzle body 10 and then rotate it in the opposite direction, and the sprinkler head 20 can be removed from the hose nozzle body 10. Another water spray head 200 to be replaced and assembled in the above-mentioned way, and FIG. 7 shows a three-dimensional view of this application after the replacement of another sprinkler head 200. As shown in FIGS. 8-11, to disassemble the other sprinkler head 200, the user also needs to press the sprinkler head 20 on the hose nozzle body 10 and rotate in the opposite direction to remove the sprinkler head 20 from the hose nozzle body 10. The replaceable design will reduce the troubles of the conventional sprinkler head that there are too few spray shapes or is difficult to disassemble and assemble after malfunction or damage, so the entire water spray gun must be abandoned.

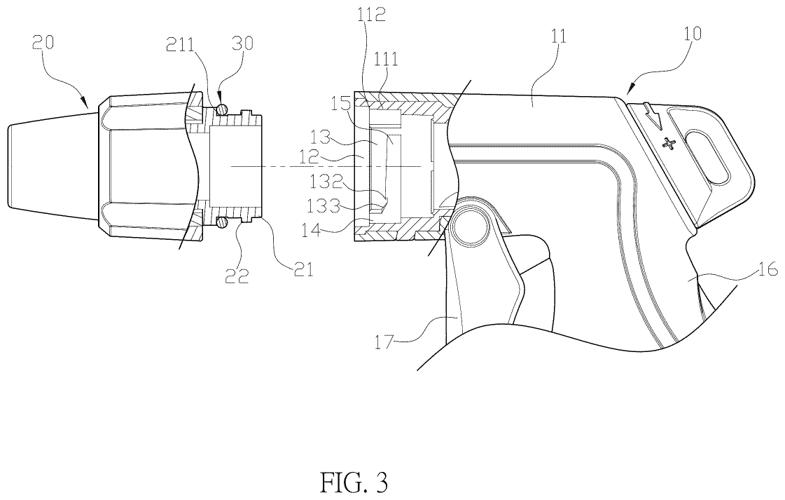

As shown in FIGS. 3-5, the sprinkler head 20 and the hose nozzle body 10 are combined and adjusted in a detailed manner as follows. The sleeve pipe 21 is inserted into the barrel part 11, and the water stop ring 30 is first deformed by being squeezed by the first stopping surface 112 and the second stop surface 211 with axial force. The extruded and deformed part of the water stop ring 30 enters between the inner side of the stopping part 111 and the outer side of the sleeve pipe 21, so that the water stop ring 30 blocks and is squeezed with radial force by the inner side of the stopping part 111 and the outer side of the sleeve pipe 21, which also causes the inner side of the stopping part 111 and the outer side of the sleeve pipe 21 to bear the elasticity of the water stop ring 30. Since the inner side of the stopping part 111 and the outer side of the sleeve pipe 21 are subject to the positive force caused by radial elasticity, the axial friction between the sprinkler head 20, the hose nozzle body 10, and the water stop ring 30 is increased, so that the sprinkler head 20 will not easily slip axially away from the hose nozzle body 10, and the sprinkler head 20 will not be accidentally detached from the hose nozzle body 10 before the projecting rib 22 is turned into the swivel slot 15. Hence, the stability of the combination of the sprinkler head 20 and the hose nozzle body 10 can be improved.

As shown in FIGS. 8-11, the water stop ring 30 is stuck between the sprinkler head 20 and the hose nozzle body 10 to achieve a force balance and is not easy to axially rotate. The sprinkler head 20 can be rotated freely without loosening. The method of quickly disassembling the sprinkler head 20 is to further press the sprinkler head 20 to move the sleeve pipe 21 further into the barrel part 11, and the water stop ring 30 is subjected to more radial extrusion and deformation into the space between the stopping part 111 and the sleeve pipe 21. At the same time, the water stop ring 30 is not only reduced in pressure by the first stopping surface 112 and the second stop surface 211, but the water stop ring 30 also begins to convert the axial contraction into radial deformation and helps the socket pipe 21 axially withdraw from the barrel part 11 without vigorously pulling out the sprinkler head 20, which is more convenient for disassembly and assembly.

The elasticity of the water stop ring 30 actively pushes the sprinkler head 20 outward to drive the projecting rib 22 into the swivel slot 15. The water stop ring 30 can also be stuck between the sprinkler head 20 and the hose nozzle body 10 to achieve a force balance and be able to rotate the sprinkler head 20 freely without loosening. The sprinkler head 20 can be further pressed to cause the water stop ring 30 to undergo more radial deformation and then shrink so that the water stop ring 30 elastically assists the sleeve pipe 21 be axially withdrawn from the barrel part 11, which can be beneficial in disassembling and assembling the sprinkler head 20.

The present invention provides a gardening hose nozzle, wherein the other end of the hose nozzle body 10 different from the port 12 is connected to a grip 16, and the grip 16 is used to connect water sources and can be held.

The present invention provides a gardening hose nozzle, wherein a water control switch 17 is provided on the hose nozzle body 10 so that the water control switch 17 can control the opening and closing of the water source.

The present invention provides a gardening hose nozzle, wherein the water control switch 17 is a push type switch.

The present invention provides a gardening hose nozzle, wherein the water stop ring 30 is a rubber ring with a circular cross-section, which has better friction, elasticity, and radial and axial deformation is relatively average and not easily compressed.

The present invention provides a gardening hose nozzle, wherein the sprinkler head 20 is a high-pressure water spray head that can adjust the spray area, as shown in FIGS. 1, 3, 4, 5, and 6.

The present invention provides a gardening hose nozzle, wherein the sprinkler head 200 is a multi-stage fancy water spray head, as shown in FIG. 7.

With the above-mentioned structure of this application, the following benefits can be obtained. First, the sprinkler head 20 or 200 can be disassembled and assembled with bare hands, so it can be replaced with different water sprays according to actual use needs. The sprinkler head 20 or 200 of different shapes or models will be more flexible in use, and there is no need to prepare multiple water spray guns at the same time for a variety of different water spray needs. Second, the sprinkler head 20 or 200 can be disassembled and assembled with bare hands, so when the sprinkler head 20 or 200 fails or is damaged, it can be easily replaced, which is relatively energy-saving, avoids waste, and be more environmentally friendly.

What is claimed is:

1. A garden hose nozzle comprising a hose nozzle body, at least one sprinkler head, and a water stop ring, wherein:
the hose nozzle body comprises a barrel part, one end of the barrel part is formed with a port, an inner wall of the barrel part is provided with a stopping part protruding inward, the stopping part has a first stopping surface close to the port, and two stoppers are protruding from the inside of the stopping part and are spaced apart from each other, an entrance channel is formed between both sides of the two stoppers, and the two stoppers each form a swivel slot in the direction away from the port, the swivel slot has a closed bottom, and the opening of the swivel slot is connected to the entrance channel; the stopper is formed a limiting block protruding from an inner end close to one side of the entrance channel, and the limiting block is provided a first inclined guide surface;
a sleeve pipe extends from one end of the sprinkler head, an outer wall of the sleeve pipe is provided with two projecting ribs that are spaced apart from each other, the projecting rib is formed a second inclined guide surface, and the sleeve pipe is provided with a second stopping surface for the water stop ring to abut and limit the axial direction movement of the water stop ring;
when the water stop ring is sleeved on the sleeve pipe, the sleeve pipe can be inserted into the barrel part of the hose nozzle body from the port by aligning the projecting rib and the entrance channel, the water stop ring is axially pushed and squeezed by the first stopping surface and the second stopping surface at the same time, and the water stop ring is also radially pressed by the inner side of the stopping part and the outer side of the sleeve pipe;
by cooperating with the elasticity of the water stop ring, the sprinkler head will not easily move relative to the hose nozzle body, the sprinkler head is rotated in one direction after insertion, so that the projecting rib can use the mutual guidance of the second inclined guide surface and the first inclined guide surface to smoothly cross the limiting block and then turn into the swivel slot, the water stop ring is supported between the hose nozzle body and the sprinkler head, and the elasticity of the water stop ring can also be used to actively push the sprinkler head to drive the projecting rib outward to snap into the swivel slot, the sprinkler head can pass through the limitation of the projecting rib caused by the stopper and the limiting block, so that it can no longer be arbitrarily separated from the hose nozzle body, thereby eliminating the need for additional tools, and the advantage of disassembly and assembly of the sprinkler head on the hose nozzle body can be completed.

2. The garden hose nozzle of claim 1, wherein the other end of the hose nozzle body different from the port is connected to a grip, and the grip is used to connect water sources and can be held.

3. The garden hose nozzle of claim 1, wherein a water control switch is provided on the hose nozzle body.

4. The garden hose nozzle of claim 3, wherein the water control switch is a push type switch.

5. The garden hose nozzle of claim 1, wherein the water stop ring is a rubber ring with a circular cross-section.
